(19) United States
(12) Patent Application Publication
(10) Pub. No.: US 2025/0383245 A1
(43) Pub. Date: Dec. 18, 2025

(54) PRESSURE SENSOR

(71) Applicant: Japan Display Inc., Tokyo (JP)

(72) Inventors: Shinichiro OKA, Tokyo (JP); Junji KOBASHI, Tokyo (JP)

(21) Appl. No.: 19/233,965

(22) Filed: Jun. 10, 2025

(30) Foreign Application Priority Data
Jun. 14, 2024 (JP) 2024-096653

(51) Int. Cl. G01L 1/20; G01L 1/22

(52) U.S. Cl. CPC G01L 1/205; G01L 1/2293

(57) ABSTRACT

According to one embodiment, a pressure sensor includes a plurality of detection areas each including a transistor, a detection electrode electrically connected to the transistor, and a first pressure-sensitive layer and a second pressure-sensitive layer each provided on the detection electrode. The first pressure-sensitive layer and the second pressure-sensitive layer have different variation ratios of resistance values in response to applied pressure.

### CROSS-REFERENCE TO RELATED APPLICATIONS

This application is based upon and claims the benefit of priority from Japanese Patent Application No. 2024-096653, filed Jun. 14, 2024, the entire contents of which are incorporated herein by reference.

### FIELD

Embodiments described herein relate generally to a pressure sensor.

### BACKGROUND

Various pressure sensors capable of detecting pressure distribution have been proposed. With respect to these pressure sensors, pressure sensors capable of detecting pressure variations in a wide pressure range are demanded.

### BRIEF DESCRIPTION OF THE DRAWINGS

FIG. 1 is a plan view showing a configuration example of a pressure sensor of the first embodiment.

FIG. 2 is a plan view showing a configuration example of the pressure sensor shown in FIG. 1.

FIG. 3 is a schematic cross-sectional view of the pressure sensor along line III-III of FIG. 2.

FIG. 4 is a circuit diagram view showing an example of circuit configurations of the pressure sensor shown in FIG. 1.

FIG. 5 is a cross-sectional view illustrating a state where an input surface of the pressure sensor shown in FIG. 1 is pressed.

FIG. 6 is a view showing an example of relationships among pressure applied to the input surface and current values.

FIG. 7 is a view showing an example of relationships among pressure applied to the input surface and current values.

FIG. 8 is a plan view showing a configuration example of a pressure sensor of the second embodiment.

FIG. 9 is a schematic cross-sectional view of the pressure sensor along line IX-IX of FIG. 8.

FIG. 10 is a plan view showing a configuration example of a pressure sensor of the third embodiment.

FIG. 11 is a schematic cross-sectional view of the pressure sensor along line XI-XI of FIG. 10.

FIG. 12 is a plan view showing an example of a pressure-sensitive layer of a pressure sensor of the configuration example 1.

FIG. 13 is a plan view showing an example of a pressure-sensitive layer of a pressure sensor of the configuration example 2.

FIG. 14 is a plan view showing an example of a pressure-sensitive layer of a pressure sensor of the configuration example 3.

FIG. 15 is a view showing an example of relationships among pressure applied to the input surface and current values.

### DETAILED DESCRIPTION

In general, according to one embodiment, a pressure sensor includes a plurality of detection areas each including a transistor, a detection electrode electrically connected to the transistor, and a first pressure-sensitive layer and a second pressure-sensitive layer each provided on the detection electrode. The first pressure-sensitive layer and the second pressure-sensitive layer have different variation ratios of resistance values in response to applied pressure.

This configuration can provide a pressure sensor capable of detecting pressure variations in a wide pressure range.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

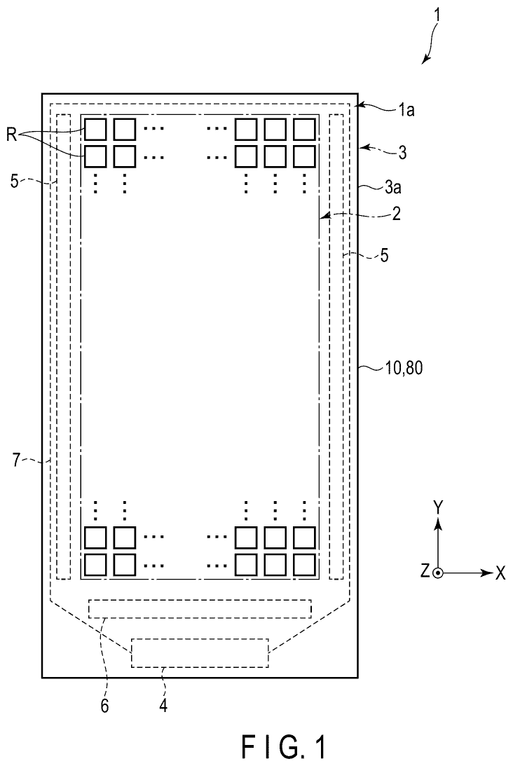

FIG. 1 is a plan view showing a configuration example of a pressure sensor 1 of the present embodiment. For example, a first direction X, a second direction Y, and a third direction Z are orthogonal to each other but may intersect at an angle other than 90 degrees. The first direction X and the second direction Y correspond to, for example, directions parallel to a main surface of a substrate constituting the pressure sensor 1, and the third direction Z corresponds to the thickness direction of the pressure sensor 1. In the present specification, a direction from a substrate 10 to an insulating layer 40 is referred to as an “upper side” (or simply, “upper” or “above”) and a direction from the insulating layer 40 to the substrate 10 is referred to as a “lower side” (or simply, “lower” or “below”). Expressions such as “a second member on/above a first member” and “a second member under/below a first member” signify that the second member may be in contact with the first member or may be spaced apart from the first member. In addition, an observation position at which the pressure sensor 1 is observed is assumed to be located on the tip side of the arrow indicating the third direction Z, and viewing from the observation position toward the X-Y plane defined by the first direction X and the second direction Y is referred to as a plan view.

In the present embodiment, the pressure sensor 1 is a pressure distribution sensor. The pressure sensor 1 comprises a substrate 10. The substrate 10 is formed into a flat plate shape parallel to the X-Y plane. For example, the substrate 10 has a rectangular shape in plan view.

In the example shown in FIG. 1, the pressure sensor 1 comprises a protective layer 80. The protective layer 80 is formed into a flat plate shape parallel to the X-Y plane. The substrate 10 and the protective layer 80 overlap in plan view.

The pressure sensor 1 has an input surface 1a on its one surface. Pressure is applied to the input surface 1a. In the example shown in FIG. 1, the pressure sensor 1 has the input surface la on the surface of the protective layer 80 opposite to a surface facing the substrate 10. The pressure sensor 1 detects pressure applied to the input surface 1a.

The input surface la comprises a detection unit 2 for detecting pressure and a non-detection unit 3 formed in a frame shape and surrounding the detection unit 2. The detection unit 2 has a plurality of detection areas R. In the example shown in FIG. 1, the plurality of detection areas R are arrayed in the first direction X and the second direction Y.

The pressure sensor 1 further comprises a connection unit 4, a gate line drive circuit 5, a signal line select circuit 6, a common wire 7, and the like. The pressure sensor 1 comprises gate lines 8 and signal lines 9 (both not shown). The connection unit 4, the gate line drive circuit 5, the signal line select circuit 6, the common wire 7, the gate lines 8, and the signal lines 9 are provided between the substrate 10 and the protective layer 80. Each of the connection unit 4, the gate line drive circuit 5, the signal line select circuit 6, and the common wire 7 overlaps the non-detection unit 3 in plan view.

The connection unit 4 connects the pressure sensor 1 with a drive integrated circuit (IC) in the exterior of the pressure sensor 1. The drive integrated circuit (IC) is not shown. The drive IC May be mounted as a chip on film (COF) on a flexible printed substrate or a rigid substrate each connected to the connection unit 4. The drive IC may be mounted as a chip on glass (COG) in an area overlapping the non-detection unit 3 of the substrate 10.

The gate line drive circuit 5 drives the plurality of gate lines 8 based on various control signals from the drive IC. The gate line drive circuit 5 sequentially or simultaneously selects the gate lines 8 and then supplies the selected gate lines 8 with gate drive signals.

The signal line select circuit 6 is a switch circuit that sequentially or simultaneously selects the signal lines 9. The signal line select circuit 6 is, for example, a multiplexer. The signal line select circuit 6 connects the selected signal lines 9 with the drive IC based on the select signals supplied from the drive IC.

The common wire 7 supplies the common electrode with a prescribed voltage and is arrayed along an outer edge 3a of the non-detection unit 3. The common wire 7 is connected to the drive IC via the connection unit 4 and is supplied with a constant voltage from the drive IC.

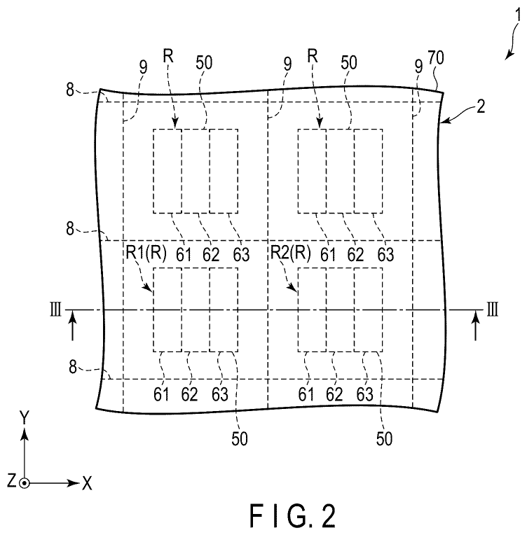

FIG. 2 is a plan view showing a configuration example of the pressure sensor 1 shown in FIG. 1. The following describes a detection unit 2 of the pressure sensor 1. FIG. 2 omits the illustration of the protective layer 80.

The pressure sensor 1 comprises the plurality of detection areas R, the common electrode 70, the plurality of gate lines 8, and the plurality of signal lines 9. The plurality of gate lines 8 are provided in the second direction Y and extend in the first direction X. In addition, the plurality of signal lines 9 are provided in the first direction X and extend in the second direction Y. In the example shown in FIG. 2, the plurality of detection areas R are arrayed in the first direction X and the second direction Y.

Each of the plurality of detection areas R comprises a detection electrode 50, a first pressure-sensitive layer 61, a second pressure-sensitive layer 62, a third pressure-sensitive layer 63, and a transistor 30 (not shown). In the example shown in FIG. 2, the detection electrode 50 has a rectangular shape in plan view.

Each of the first pressure-sensitive layer 61, the second pressure-sensitive layer 62, and the third pressure-sensitive layer 63 overlaps the detection electrode 50. In the example shown in FIG. 2, the first pressure-sensitive layer 61, the second pressure-sensitive layer 62, and the third pressure-sensitive layer 63 are arranged in the first direction X in this order. For example, the first pressure-sensitive layer 61, the second pressure-sensitive layer 62, and the third pressure-sensitive layer 63 have a rectangular shape of the same size in plan view. The first pressure-sensitive layer 61, the second pressure-sensitive layer 62, and the third pressure-sensitive layer 63, when combined as a whole, have the same shape as that of the detection electrode 50.

In the example shown in FIG. 2, each of the plurality of detection areas R has three types of the pressure-sensitive layers: the first pressure-sensitive layer 61, the second pressure-sensitive layer 62, and the third pressure-sensitive layer 63. The configuration of the detection area R is not limited to this example. Each of the detection areas R comprises at least two types of the pressure-sensitive layers and may comprise four or more types of the pressure-sensitive layers.

The common electrode 70 overlaps the first pressure-sensitive layer 61, the second pressure-sensitive layer 62, and the third pressure-sensitive layer 63 in plan view. In the example shown in FIG. 2, the common electrode 70 overlaps each of the plurality of detection areas R. For example, the common electrode 70 overlaps the input surface la of the pressure sensor 1 in plan view.

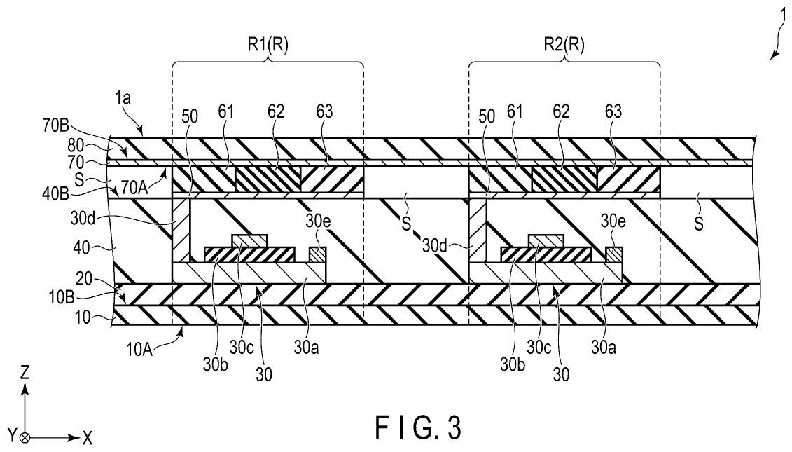

FIG. 3 is a schematic cross-sectional view of the pressure sensor 1 along line III-III of FIG. 2.

The pressure sensor 1 comprises the substrate 10, an insulating layer 20, the transistor 30, an insulating layer 40, the detection electrode 50, the first pressure-sensitive layer 61, the second pressure-sensitive layer 62, the third pressure-sensitive layer 63, the common electrode 70, and the protective layer 80. The pressure sensor 1 further comprises the connection unit 4, the gate line drive circuit 5, the signal line select circuit 6, and the common wire 7 that are shown in FIG. 1. The pressure sensor 1 further comprises the gate lines 8 and the signal lines 9 shown in FIG. 2.

The substrate 10 has a main surface (lower surface) 10A and a main surface (upper surface) 10B on the side opposite to the main surface 10A. The main surfaces 10A and 10B are the surfaces substantially parallel to the X-Y plane. The insulating layer 20 covers the main surface 10B. The transistor 30 is provided on the insulating layer 20. The transistor 30 is provided per the detection area R.

The transistor 30 comprises a semiconductor layer 30a, a gate insulating film 30b, a gate electrode 30c, a drain electrode 30d, and a source electrode 30e. The semiconductor layer 30a is provided on the insulating layer 20. The gate insulating film 30b is provided on the semiconductor layer 30a. The gate electrode 30c is provided on the gate insulating film 30b. The drain electrode 30d is provided on the semiconductor layer 30a. The drain electrode 30d is electrically connected to the gate line 8 (not shown). The source electrode 30e is provided on the semiconductor layer 30a. The source electrode 30e is electrically connected to the signal line 9 (not shown).

The insulating layer 40 covers the insulating layer 20 and the transistor 30. The insulating layer 40 comprises a surface 40B facing the protective layer 80. The surface 40B is planarized. Though not shown, the connection unit 4, the gate line drive circuit 5, the signal line select circuit 6, the common wire 7, the gate line 8, and the signal line 9 are provided between the main surface 10B and the surface 40B.

The detection electrode 50 is provided on the surface 40B. The detection electrode 50 is provided per the detection area R. The surface 40B is exposed between the detection electrodes 50 adjacent to each other. The detection electrode 50 is electrically connected to the drain electrode 30d and the transistor 30.

Each of the first pressure-sensitive layer 61, the second pressure-sensitive layer 62, and the third pressure-sensitive layer 63 is provided on the detection electrode 50. In the example shown in FIG. 3, the first pressure-sensitive layer 61, the second pressure-sensitive layer 62, and the third pressure-sensitive layer 63 are arranged in the first direction X in this order and provided on the detection electrode 50. In the example shown in FIG. 3, the first pressure-sensitive layer 61 contacts the second pressure-sensitive layer 62. The configuration is not limited to this example. The first pressure-sensitive layer 61 and the second pressure-sensitive layer 62 may be spaced apart from each other. Further, the second pressure-sensitive layer 62 contacts the third pressure-sensitive layer 63. The configuration is not limited to this example. The second pressure-sensitive layer 62 and the third pressure-sensitive layer 63 may be spaced apart from each other.

The common electrode 70 is provided on the first pressure-sensitive layer 61, the second pressure-sensitive layer 62, and the third pressure-sensitive layer 63. The common electrode 70 has a surface 70A facing the substrate 10 and a substrate 70B on the side opposite to the surface 70A. The protective layer 80 covers the surface 70B. For example, the common electrode 70 is a metal film formed on a surface on the side opposite to the input surface la of the protective layer 80. The pressure sensor 1 may not comprise the protective layer 80. At this time, the substrate 70B of the common electrode 70 serves as the input surface 1a.

With respect to detection areas R1 and R2, two detection areas adjacent to each other, the pressure sensor 1 has a gap S between the surface 40B and the surface 70A in space between the detection area R1 and the detection area R2. In the example shown in FIG. 3, the detection electrode 50 of the detection area R1 is adjacent to the detection electrode 50 of the detection area R2 via the gap S. The third pressure-sensitive layer 63 of the detection area R1 is adjacent to the first pressure-sensitive layer 61 of the detection area R2 via the gap S.

In the examples shown in FIG. 2 and FIG. 3, the detection electrode 50 and the common electrode 70 are provided to face each other. That is, the pressure sensor 1 comprises what is called a facing-type electrode.

The substrate 10 is an insulating substrate or an insulating film. For example, the substrate 10 is a substrate or a film each formed of glass, resin, or the like. The insulating layers 20 and 40 are inorganic or organic insulating films. The protective layer 80 is a substrate or a film each insulating and flexible. For example, the protective layer 80 is a substrate or a firm each formed of a resin and the like.

The detection electrodes 50 and the common electrodes 70 are formed of a metal material such as indium tin oxide (ITO), for example.

Each of the first pressure-sensitive layer 61, the second pressure-sensitive layer 62, and the third pressure-sensitive layer 63 is formed of an insulating resin containing conductive materials. The conductive materials are, for example, conductive particles. The conductive materials are dispersed in an insulating resin to be spaced apart from one another. Each of the first pressure-sensitive layer 61, the second pressure-sensitive layer 62, and the third pressure-sensitive layer 63 is a conductive elastomer prepared by mixing rubber member with conductive material. For example, the first pressure-sensitive layer 61, the second pressure-sensitive layer 62, and the third pressure-sensitive layer 63 each may be formed by applying insulating resin containing conductive materials by means of an ink-jet and the like.

When no pressure is applied to such pressure-sensitive layers formed of insulating resin containing conductive materials, the conductive materials in the insulating resin are spaced apart from one another. Thus, the pressure-sensitive layer in this state has a great resistance value. When pressure is applied to the pressure-sensitive layer, the insulating resin deforms and thus the conductive materials in the insulating resin are brought into contact with one another or close proximity. This reduces the resistance value of the pressure-sensitive layer. When pressure is further applied to the pressure-sensitive layer and deformation amount of the insulating resin further increases, the amount of the conductive materials that are in contact with one another or close proximity increases. This further reduces the resistance value of the pressure-sensitive layer. In this manner, the resistance value of the pressure-sensitive layer formed of the insulating resin containing the conductive materials varies in response to pressure applied to the pressure-sensitive layer.

The first pressure-sensitive layer 61, the second pressure-sensitive layer 62, and the third pressure-sensitive layer 63 have different variation ratios of resistance values in response to applied pressure. For example, the degrees of variations in resistance values in response to variations in pressure may be adjusted by varying contents of the conductive materials in the insulating resins. Alternatively, the degrees of variations in resistance values in response to variations in pressure may be adjusted by varying conductivities of the conductive materials in the insulating resins. Alternatively, the degrees of variations in resistance values in response to variations in pressure may be adjusted by varying hardnesses of the insulating resins.

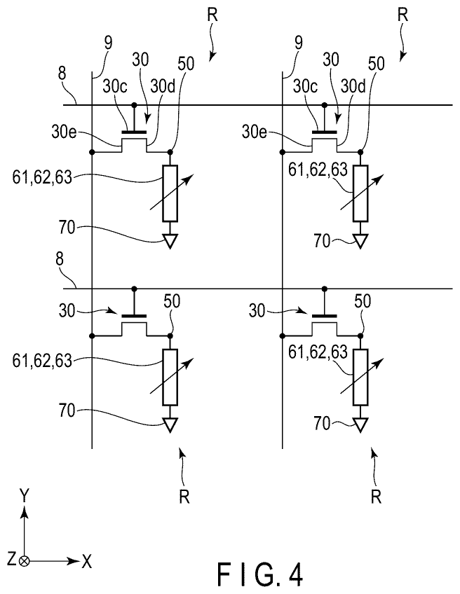

FIG. 4 is a circuit diagram showing an example of circuit configurations of the pressure sensor 1 shown in FIG. 1. As shown in FIG. 4, the gate electrode 30c is electrically connected to the gate line 8. The source electrode 30e is electrically connected to the signal line 9. That is, the transistors 30 are electrically connected to the gate line 8 and the signal line 9.

The gate line 8 extends in the first direction X and is electrically connected to each of the transistors 30 in the plurality of detection areas R arrayed in the first direction X. The signal line 9 extends in the second direction Y, intersects the gate line 8, and is electrically connected to each of the transistors 30 in each of the plurality of detection areas R arrayed in the second direction Y. The detection electrode 50 is electrically connected to the drain electrode 30d.

Scanning the gate line 8 electrically connects the detection electrode 50 with the signal line 9. Thus, a value of a current flowing between the detection electrode 50 and the common electrode 70 can be obtained via the signal line 9. Pressure applied to the input surface la can be detected based on this obtained current value.

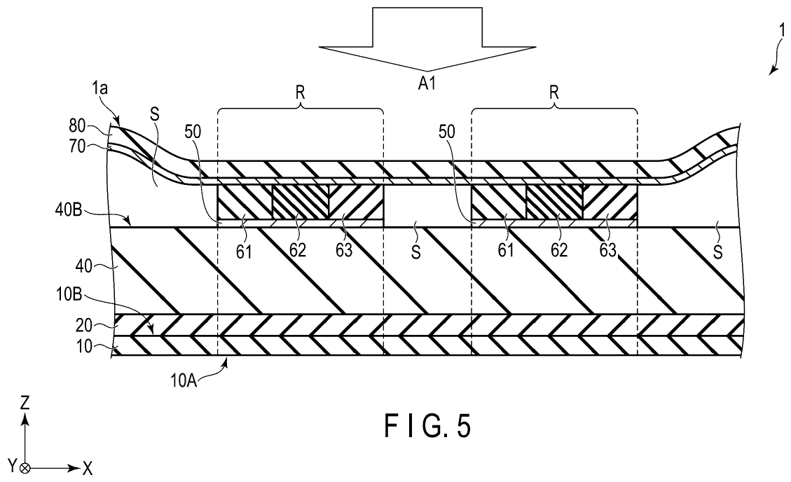

FIG. 5 is a cross-sectional view illustrating a state where the input surface la of the pressure sensor 1 is pressed. FIG. 5 omits the illustration of the transistors 30.

When the input surface la of the pressure sensor 1 is not pressed, each of the first pressure-sensitive layer 61, the second pressure-sensitive layer 62, and the third pressure-sensitive layer 63 has a greater resistance value. The detection electrode 50 overlaps the common electrode 70 in the third direction Z via the first pressure-sensitive layer 61, the second pressure-sensitive layer 62, or the third pressure-sensitive layer 63. Thus, when the input surface 1a is not pressed, the detection electrode 50 and the common electrode 70 are electrically disconnected from each other.

As shown in FIG. 5, for example, when the input surface la is pressed by fingers and the like, pressure in a direction from the protective layer 80 to the substrate 10, in other words, in an A1 direction is applied to the input surface 1a. At this time, each of the first pressure-sensitive layer 61, the second pressure-sensitive layer 62, and the third pressure-sensitive layer 63 each is compressed in the A1 direction. Thus, the conductive materials contained in each of the first pressure-sensitive layer 61, the second pressure-sensitive layer 62, and the third pressure-sensitive layer 63 are brought into contact with one another or close proximity. This reduces the resistance value of the first pressure-sensitive layer 61, the second pressure-sensitive layer 62, and the third pressure-sensitive layer 63. Thus, a current flows between the detection electrode 50 and the common electrode 70.

When the pressure in the A1 direction applied to the surface la increases, each of the first pressure-sensitive layer 61, the second pressure-sensitive layer 62, and the third pressure-sensitive layer 63 is further compressed in the A1 direction. This increases the amount of the conductive materials that are brought into contact with one another or close proximity. This further reduces the resistance value of each of the first pressure-sensitive layer 61, the second pressure-sensitive layer 62, and the third pressure-sensitive layer 63, increasing a current flowing between the detection electrode 50 and the common electrode 70. That is, as pressure applied to the input surface 1a increases, a value of a current (current value) flowing between the detection electrode 50 and the common electrode 70 increases. Variations in pressure applied to the input surface 1a can be detected by detecting such variations in the current value.

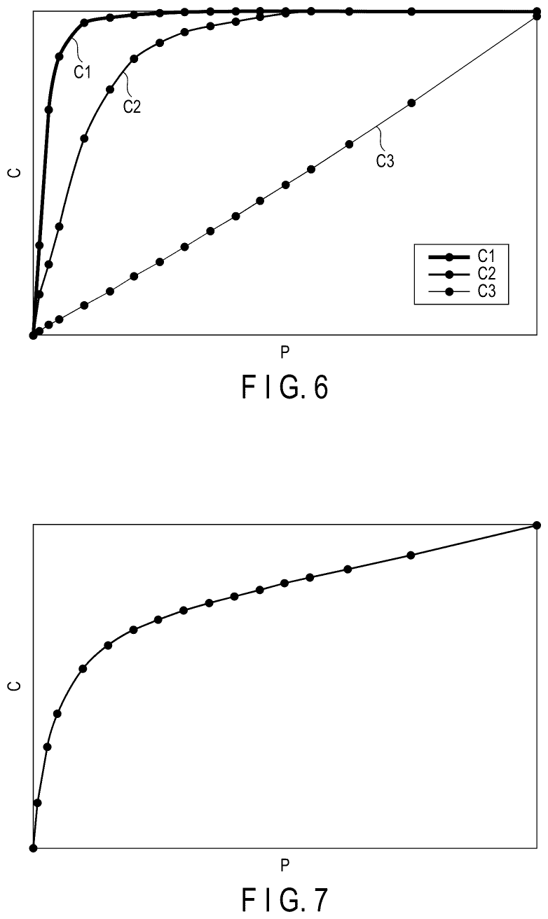

FIG. 6 and FIG. 7 are views showing an example of relationships among pressures P applied to the input surface 1a and current values C.

The first pressure-sensitive layer 61, the second pressure-sensitive layer 62, and the third pressure-sensitive layer 63 have different variation ratios of resistance values in response to pressures P.

Thus, with respect to the relationships among the pressures P and the current values C, the current value C1, the current value C2, and the current value C3 are shown by different curved lines, for example, as shown in FIG. 6. That is, how a current C varies in response to pressures P differs between the first pressure-sensitive layer 61, the second pressure-sensitive layer 62, and the third pressure-sensitive layer 63.

In the pressure sensor 1 comprising the first pressure-sensitive layer 61, the second pressure-sensitive layer 62, and the third pressure-sensitive layer 63, a current value C of a current flowing between the detection electrode 50 and the common electrode 70 can be obtained as an average of a current value C1 of a current flowing through the first pressure-sensitive layer 61, a current value C2 of a current flowing through the second pressure-sensitive layer 62, and a current value C3 of a current flowing through the third pressure-sensitive layer 63.

The present embodiment can provide a pressure sensor capable of detecting pressure variations in the broad range.

The pressure sensor 1 comprises a plurality of detection areas R. Each of the plurality of detection areas R comprises the first pressure-sensitive layer 61 and the second pressure-sensitive layer 62. The first pressure-sensitive layer 61 and the second pressure-sensitive layer 62 have different variation ratios of resistance values in response to applied pressure. That is, how a current value C varies in response to pressures P applied to the input surface 1a differs between the first pressure-sensitive layer 61 and the second pressure-sensitive layer 62. Thus, the first pressure-sensitive layer 61 and the second pressure-sensitive layer 62 have different ranges in which the variations in the pressure can be detected and different pressure sensitivities. In the example shown in FIG. 6, the first pressure-sensitive layer 61 can detect variations in the pressures P at low pressure with high sensitivity. Although the second pressure-sensitive layer 62 has a lower sensitivity at low pressure than the first pressure-sensitive layer 61, it has broader range in which variations in the pressures P can be detected than that of the first pressure-sensitive layer 61. In the pressure sensor 1 comprising the first pressure-sensitive layer 61 and the second pressure-sensitive layer 62, a current value C flowing between the detection electrode 50 and the common electrode 70 can be, for example, obtained as the average of the current values C1 and C2. Thus, the pressure sensor 1 comprising both of the first pressure-sensitive layer 61 and the second pressure-sensitive layer 62 can detect variations in the pressures P in the broader range of the pressures P than a pressure sensor that comprises the first pressure-sensitive layer 61 alone. Further, the pressure sensor 1 can detect variations in the pressures P at low pressure with higher sensitivity than a pressure sensor that comprises the second pressure-sensitive layer 62 alone.

In this manner, the present embodiment can provide a pressure sensor capable of detecting pressure variations in the broad range. Further, the detection sensitivity of the pressure sensor can be improved in a desired pressure range.

### Second Embodiment

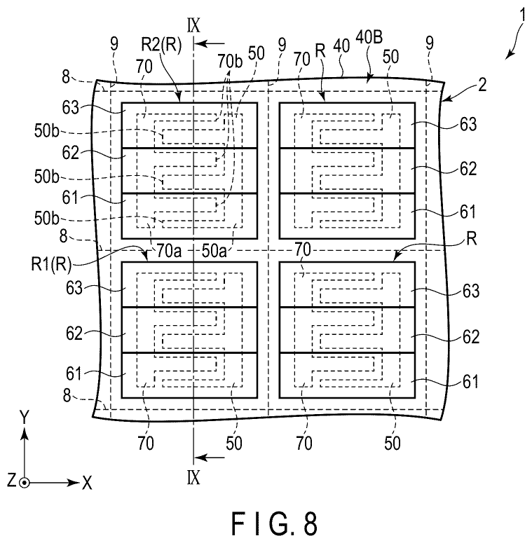

FIG. 8 is a plan view showing a configuration example of a pressure sensor 1 according to the second embodiment. Configurations corresponding to those in the first embodiment adopt the above explanations, and explanations of these corresponding configurations are omitted. The following describes a detection unit 2 of the pressure sensor 1. FIG. 8 omits the illustration of the protective layer 80.

Each of a plurality of detection areas R comprises a detection electrode 50, a first pressure-sensitive layer 61, a second pressure-sensitive layer 62, a third pressure-sensitive layer 63, a common electrode 70, and a transistor 30 (not shown). The detection electrode 50 comprises an electrode 50a extending in the second direction Y and a plurality of electrodes 50b extending in the first direction X from the electrode 50a. The common electrode 70 comprises an electrode 70a extending in the second direction Y and a plurality of electrodes 70b extending in the first direction X from the electrode 70a. The electrodes 50b and the electrodes 70b are alternately arranged in the second direction Y. In the example shown in FIG. 8, three detection electrodes 50b and three electrodes 70b are provided per the detection area R.

Each of the first pressure-sensitive layer 61, the second pressure-sensitive layer 62, and the third pressure-sensitive layer 63 overlaps the detection electrode 50 and the common electrode 70. In the example shown in FIG. 8, each of the first pressure-sensitive layer 61, the second pressure-sensitive layer 62, and the third pressure-sensitive layer 63 overlaps one of the plurality of electrodes 50b and one of the plurality of electrodes 70b. For example, the first pressure-sensitive layer 61, the second pressure-sensitive layer 62, and the third pressure-sensitive layer 63 are arranged in the second direction Y in this order. For example, the first pressure-sensitive layer 61, the second pressure-sensitive layer 62, and the third pressure-sensitive layer 63 have a rectangular shape of the same size in plan view. For example, the first pressure-sensitive layer 61, the second pressure-sensitive layer 62, and the third pressure-sensitive layer 63, when combined as a whole, have a rectangular shape.

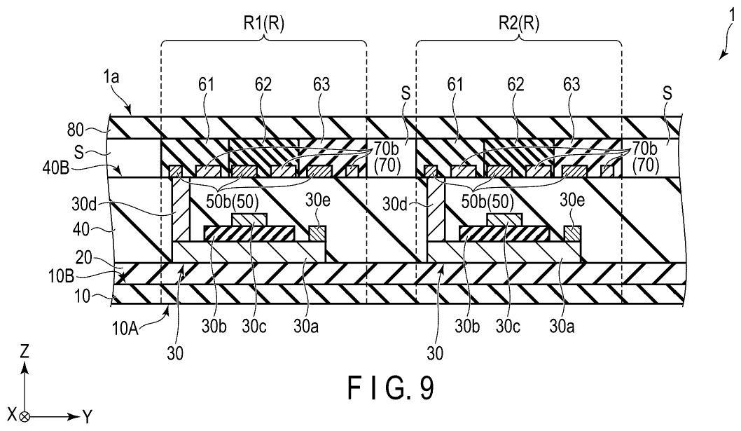

FIG. 9 is a schematic cross-sectional view of the pressure sensor 1 along line IX-IX of FIG. 8.

The detection electrode 50 and the common electrode 70 are provided on a surface 40B. The electrode 50b of the detection electrode 50 and the electrode 70b of the common electrode 70 are alternately arranged in the second direction Y.

Each of the first pressure-sensitive layer 61, the second pressure-sensitive layer 62, and the third pressure-sensitive layer 63 is provided on the detection electrode 50 and the common electrode 70. In the example shown in FIG. 9, the first pressure-sensitive layer 61, the second pressure-sensitive layer 62, and the third pressure-sensitive layer 63 are arranged in the second direction Y in this order. Each of the first pressure-sensitive layer 61, the second pressure-sensitive layer 62, and the third pressure-sensitive layer 63 covers one of the plurality of electrodes 50b and one of the plurality of electrodes 70b. The first pressure-sensitive layer 61, the second pressure-sensitive layer 62, and the third pressure-sensitive layer 63 contact the surface 40B between the electrode 50b and the electrode 70b.

The protective layer 80 covers the first pressure-sensitive layer 61, the second pressure-sensitive layer 62, and the third pressure-sensitive layer 63. The pressure sensor 1 may not comprise the protective layer 80. That is, a surface opposite to the surface facing the surface 40B of the first pressure-sensitive layer 61, the second pressure-sensitive layer 62, and the third pressure-sensitive layer 63 is an input surface 1a.

With respect to detection areas R1 and R2, two detection areas adjacent to each other, the pressure sensor 1 has a gap S between the surface 40B and the surface of the protective layer 80 facing the surface 40B in space between the detection area R1 and the detection area R2. In the example shown in FIG. 9, the third pressure-sensitive layer 63 of the detection area R1 is adjacent to the first pressure-sensitive layer 61 of the detection area R2 via the gap S.

In the examples shown in FIG. 8 and FIG. 9, the detection electrode 50 and the common electrode 70 are provided on the same plane. That is, the pressure sensor 1 comprises what is called a parallel-type electrode.

The pressure sensor 1 according to the second embodiment can achieve the same effects as those of the first embodiment.

### Third Embodiment

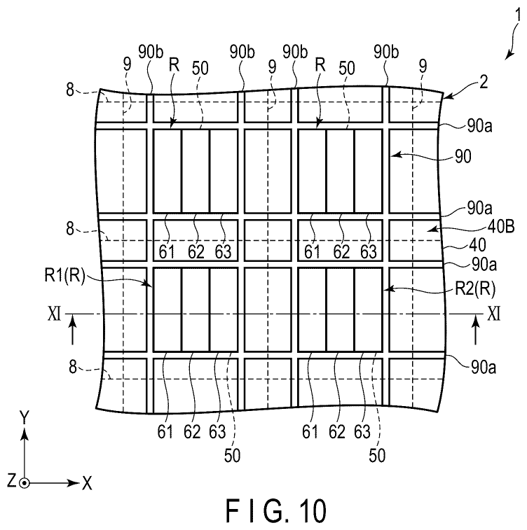

FIG. 10 is a plan view showing a configuration example of a pressure sensor 1 according to the third embodiment. Configurations corresponding to those in the first embodiment adopt the above explanations, and explanations of these corresponding configurations are omitted. The following describes a detection unit 2 of the pressure sensor 1. FIG. 8 omits the illustration of the common electrode 70 and the protective layer 80.

The pressure sensor 1 comprises a plurality of detection areas R. Each of the plurality of detection areas R comprises a detection electrode 50, a first pressure-sensitive layer 61, a second pressure-sensitive layer 62, a third pressure-sensitive layer 63, and a transistor 30 (not shown). Each of the first pressure-sensitive layer 61, the second pressure-sensitive layer 62, and the third pressure-sensitive layer 63 overlaps the detection electrode 50. In the example shown in FIG. 10, the first pressure-sensitive layer 61, the second pressure-sensitive layer 62, and the third pressure-sensitive layer 63 are arranged in the first direction X in this order. For example, the first pressure-sensitive layer 61, the second pressure-sensitive layer 62, and the third pressure-sensitive layer 63 have a rectangular shape of the same size in plan view. The first pressure-sensitive layer 61, the second pressure-sensitive layer 62, and the third pressure-sensitive layer 63, when combined as a whole, have the same shape as that of the detection electrode 50.

The pressure sensor 1 comprises a partition 90. The partition 90 is provided between two detection areas R adjacent to each other. In the example shown in FIG. 10, the partitions 90 include a plurality of first partitions 90a arrayed in the second direction Y and extending in the first direction X and a plurality of second partitions 90b arrayed in the first direction X and extending in the second direction Y. Two of the first partitions 90a are provided between the detection areas R adjacent to each other in the second direction Y. Two of the second partitions 90b are provided between the detection areas R adjacent to each other in the first direction X. The first partition 90a and the second partition 90b intersecting each other are connected to each other. Thus, the partitions 90, when combined as a whole, are formed into a lattice shape surrounding each of the plurality of detection areas R.

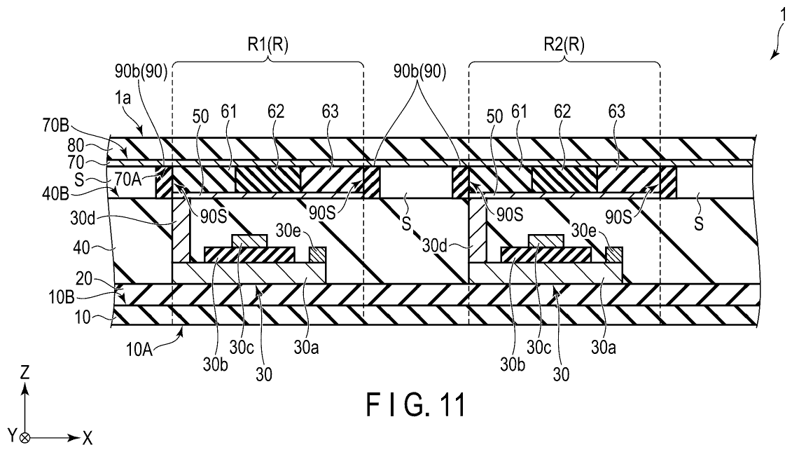

FIG. 11 is a schematic cross-sectional view of the pressure sensor 1 along line XI-XI of FIG. 10.

The detection electrode 50 is provided per the detection area R on the surface 40B. Each of the first pressure-sensitive layer 61, the second pressure-sensitive layer 62, and the third pressure-sensitive layer 63 is provided on the detection electrode 50. In the example shown in FIG. 11, the first pressure-sensitive layer 61, the second pressure-sensitive layer 62, and the third pressure-sensitive layer 63 are arranged in the first direction X in this order and provided on the detection electrode 50. The common electrode 70 is provided on the first pressure-sensitive layer 61, the second pressure-sensitive layer 62, the third pressure-sensitive layer 63, and the partition 90.

The partition 90 is provided on the surface 40B between the detection areas R1 and R2 adjacent to each other. The partition 90 has a side surface 90S facing the pressure-sensitive layer. In the example shown in FIG. 11, the side surface 90S contacts the side surface of the pressure-sensitive layer 61 or the third pressure-sensitive layer 63. The pressure sensor 1 has a gap S between the surface 40B and the surface 70A in space between adjacent partitions 90. For example, the partition 90 is formed of an insulating material.

For example, the pressure sensor 1 according to the third embodiment is applicable to the pressure sensor 1 comprising the parallel-type electrode. The pressure sensor 1 according to the third embodiment can achieve the same effects as those of the first embodiment.

### Configuration Example of Pressure-Sensitive Layers

### Configuration Example 1

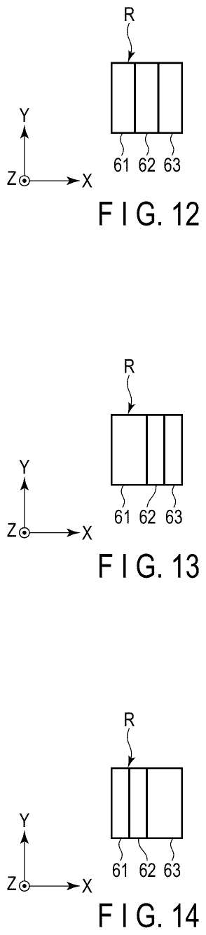

FIG. 12 is a plan view showing an example of the pressure-sensitive layer of the pressure sensor 1 of the configuration example 1. Configurations corresponding to those in the first embodiment adopt the above explanations, and explanations of these corresponding configurations are omitted. In FIG. 12, one detection area R of the plurality of detection areas R is shown. FIG. 12 omits the illustration of the detection electrode 50, the common electrode 70, and the protective layer 80.

Each of the plurality of detection areas R comprises the first pressure-sensitive layer 61, the second pressure-sensitive layer 62, and the third pressure-sensitive layer 63. In the example shown in FIG. 12, the first pressure-sensitive layer 61, the second pressure-sensitive layer 62, and the third pressure-sensitive layer 63 are arranged in the first direction X in this order. For example, the first pressure-sensitive layer 61, the second pressure-sensitive layer 62, and the third pressure-sensitive layer 63 have the same size in plan view. That is, in the example shown in FIG. 12, the ratio of the size in plan view between the first pressure-sensitive layer 61, the second pressure-sensitive layer 62, and the third pressure-sensitive layer 63 (the first pressure-sensitive layer 61:the second pressure-sensitive layer 62:the third pressure-sensitive layer 63) is 1:1:1. For example, the first pressure-sensitive layer 61, the second pressure-sensitive layer 62, and the third pressure-sensitive layer 63 have a rectangular shape.

### Configuration Example 2

FIG. 13 is a plan view showing an example of the pressure-sensitive layer of the pressure sensor 1 of the configuration example 2. Configurations corresponding to those in the configuration example 1 adopt the above explanations and explanations of these corresponding configurations are omitted. In FIG. 13, one detection area R of the plurality of detection areas R is shown. FIG. 13 omits the illustration of the detection electrode 50, the common electrode 70, and the protective layer 80.

The pressure sensor 1 of the configuration example 2 is different from the configuration example 1 in that the first pressure-sensitive layer 61 has a size in plan view different from that of the second pressure-sensitive layer 62 and the third pressure-sensitive layer 63. For example, the first pressure-sensitive layer 61 has the size in plan view greater than that of the second pressure-sensitive layer 62. In the example shown in FIG. 13, the first pressure-sensitive layer 61 has twice the size of the second pressure-sensitive layer 62. Further, the third pressure-sensitive layer 63 and the second pressure-sensitive layer 62 have the same size in plan view. That is, in the example shown in FIG. 13, the ratio of the size in plan view between the first pressure-sensitive layer 61, the second pressure-sensitive layer 62, and the third pressure-sensitive layer 63 (the first pressure-sensitive layer 61:the second pressure-sensitive layer 62:the third pressure-sensitive layer 63) is 2:1:1.

### Configuration Example 3

FIG. 14 is a plan view showing an example of the pressure-sensitive layer of the pressure sensor 1 of the configuration example 3. Configurations corresponding to those in the configuration example 1 adopt the above explanations and explanations of these corresponding configurations are omitted. In FIG. 14, one detection area R of the plurality of detection areas R is shown. FIG. 12 omits the illustration of the detection electrode 50, the common electrode 70, and the protective layer 80.

The pressure sensor 1 of the configuration example 3 is different from the configuration example 1 in that the third pressure-sensitive layer 63 has a size in plan view different from that of the first pressure-sensitive layer 61 and the second pressure-sensitive layer 62. For example, the third pressure-sensitive layer 63 has the size in plan view greater than that of the first pressure-sensitive layer 61. In the example shown in FIG. 14, the third pressure-sensitive layer 63 has twice the size of the first pressure-sensitive layer 61. Further, the second pressure-sensitive layer 62 and the first pressure-sensitive layer 61 have the same size in plan view. That is, in the example shown in FIG. 14, the ratio of the size in plan view between the first pressure-sensitive layer 61, the second pressure-sensitive layer 62, and the third pressure-sensitive layer 63 is 1:1:2 (the first pressure-sensitive layer 61:the second pressure-sensitive layer 62:the third pressure-sensitive layer 63).

Each of the plurality of detection areas R in the configuration examples 1 to 3 respectively show in FIG. 12 to FIG. 14 has three types of the pressure-sensitive layers:the first pressure-sensitive layer 61, the second pressure-sensitive layer 62, and the third pressure-sensitive layer 63. The configuration of the detection area R is not limited to this example. The detection area R comprises at least two types of the pressure-sensitive layers and may comprise four or more types of the pressure-sensitive layers. For example, the pressure sensors of the configuration examples 1 to 3 respectively shown in FIGS. 12 to 14 are applicable to the facing-type pressure sensor 1 and the parallel-type pressure sensor 1.

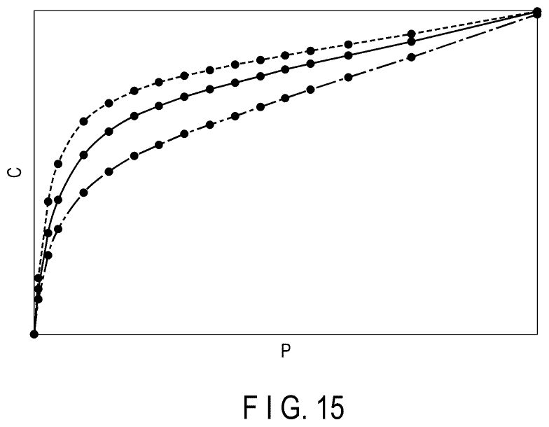

FIG. 15 is a view showing an example of relationships among pressures P applied to the input surface 1a and current values C of currents flowing between the detection electrode 50 and the common electrode 70 in the pressure sensor 1 of the configuration examples 1 to 3 respectively shown in FIG. 12 to FIG. 14. In FIG. 15, the current value C of the pressure sensor 1 in the configuration example 1 shown in FIG. 12 is shown in a solid line, the current value C of the pressure sensor 1 in the configuration example 2 shown in FIG. 13 is shown in a broken line, and the current value C of the pressure sensor 1 in the configuration example 3 shown in FIG. 14 is shown in a one-dot chain line.

Thus, with respect to the relationships among the pressures P and the current values C, the current value C1, the current value C2, and the current value C3 are shown by different curved lines, for example, as shown in FIG. 6. That is, how a current C varies in response to pressures P differs between the first pressure-sensitive layer 61, the second pressure-sensitive layer 62, and the third pressure-sensitive layer 63.

Further, the first pressure-sensitive layer 61 can detect variations in the pressures P at low pressure with higher sensitivity than the second pressure-sensitive layer 62 and the third pressure-sensitive layer 63. Further, the third pressure-sensitive layer 63 can detect variations in the pressures P at high pressure with higher sensitivity than the first pressure-sensitive layer 61 and the second pressure-sensitive layer 62.

The pressure sensor 1 shown in FIG. 13 has the first pressure-sensitive layer 61 whose area in which variations in the pressures P at low pressure can be detected with high sensitivity is greater than the other pressure-sensitive layers. Thus, as shown in FIG. 15, the pressure sensor 1 shown in FIG. 13 can detect variations in the pressures P at low pressure with higher sensitivity than the pressure sensor 1 shown in FIG. 12, which has the pressure-sensitive layers of the same size in plan view.

The pressure sensor shown in FIG. 14 has the third pressure-sensitive layer 63 whose area in which variations in the pressures P at high pressure can be detected with high sensitivity is greater than the other pressure-sensitive layers. Thus, as shown in FIG. 15, the pressure sensor 1 shown in FIG. 14 can detect variations in the pressures P at high pressure with higher sensitivity than the pressure sensor 1 shown in FIG. 12, which has the pressure-sensitive layers of the same size in plan view.

In this manner, the sensitivity of the pressure sensor in a desired pressure range can be more improved by varying the sizes in plan view of the pressure-sensitive layers. The pressure sensors 1 of the configuration examples 1 to 3 can achieve the same effects as those of the first embodiment.

As described above, the present embodiment can provide a pressure sensor capable of detecting variations in pressure in the broader pressure range.

While certain embodiments have been described, these embodiments have been presented by way of example only, and are not intended to limit the scope of the inventions. Various aspects of the invention can also be extracted from any appropriate combination of a plurality of constituent elements disclosed in the embodiments. For example, some structural elements may be deleted from the entire structural elements in the embodiments. Furthermore, structural elements described in different embodiments may be combined suitably.

What is claimed is:

1. A pressure sensor, comprising:
a plurality of detection areas; wherein
each of the plurality of detection areas includes a transistor, a detection electrode electrically connected to the transistor, and a first pressure-sensitive layer and a second pressure-sensitive layer each provided on the detection electrode, and
the first pressure-sensitive layer and the second pressure-sensitive layer have different variation ratios of resistance values in response to applied pressure.

2. The pressure sensor of claim 1, wherein
the first pressure-sensitive layer and the second pressure-sensitive layer have the same size in plan view.

3. The pressure sensor of claim 1, wherein
the first pressure-sensitive layer and the second pressure-sensitive layer have different sizes in plan view.

4. The pressure sensor of claim 1, further comprising:
a plurality of gate lines extending in the first direction; and
a plurality of signal lines extending in a second direction orthogonal to the first direction, wherein
the plurality of first detection areas are arrayed in the first direction and the second direction.

5. The pressure sensor of claim 4, wherein
the first pressure-sensitive layer and the second pressure-sensitive layer are arrayed in the first direction.

6. The pressure sensor of claim 4, wherein
the first pressure-sensitive layer and the second pressure-sensitive layer are arrayed in the second direction.

7. The pressure sensor of claim 1, further comprising:
a common electrode provided on the first pressure-sensitive layer and the second pressure-sensitive layer.

8. The pressure sensor of claim 1, further comprising:
an insulating layer covering the transistor, and
a common electrode provided on the insulating layer, wherein
the detection electrode is provided on the insulating layer.

9. The pressure sensor of claim 1, further comprising:
an insulating layer covering the transistor, and
a partition provided on the insulating layer.

10. The pressure sensor of claim 1, wherein
the first pressure-sensitive layer and the second pressure-sensitive layer each are formed of an insulating resin containing conductive materials.

11. The pressure sensor of claim 10, wherein
the first pressure-sensitive layer and the second pressure-sensitive layer have different contents of the conductive materials contained in the insulating resin.

12. The pressure sensor of claim 10, wherein
the first pressure-sensitive layer and the second pressure-sensitive layer have different conductivities of the conductive materials contained in the insulating resin.

13. The pressure sensor of claim 10, wherein
the first pressure-sensitive layer and the second pressure-sensitive layer have different hardnesses of the insulating resin.

14. The pressure sensor of claim 1, further comprising:
a third pressure-sensitive layer provided on the detection electrode, wherein
the first pressure-sensitive layer, the second pressure-sensitive layer, and the third pressure-sensitive layer have different variation ratios of resistance values in response to applied pressure.

15. The pressure sensor of claim 14, wherein
the first pressure-sensitive layer, the second pressure-sensitive layer, and the third pressure-sensitive layer have the same size in plan view.

16. The pressure sensor of claim 14, wherein
the third pressure-sensitive layer has a size in plan view different from at least one of those of the first pressure-sensitive layer and the second pressure-sensitive layer.

17. The pressure sensor of claim 14, wherein
the first pressure-sensitive layer, the second pressure-sensitive layer, and the third pressure-sensitive layer each are formed of an insulating resin containing conductive materials.

18. The pressure sensor of claim 17, wherein
the first pressure-sensitive layer, the second pressure-sensitive layer, and the third pressure-sensitive layer have different contents of the conductive materials contained in the insulating resin.

19. The pressure sensor of claim 17, wherein
the first pressure-sensitive layer, the second pressure-sensitive layer, and the third pressure-sensitive layer have different conductivities of the conductive materials contained in the insulating resin.

20. The pressure sensor of claim 17, wherein
the first pressure-sensitive layer, the second pressure-sensitive layer, and the third pressure-sensitive layer have different hardnesses of the insulating resin.
